(19) United States
(12) Patent Application Publication
(10) Pub. No.: US 2018/0094127 A1
(43) Pub. Date: Apr. 5, 2018

(54) POLYOLEFIN BASED STRETCHED FILMS INCORPORATING DISPERSED AGENTS FOR OPTIMIZATION OF APPLICATION

(71) Applicant: Dow Global Technologies LLC, Midland, MI (US)

(72) Inventors: Justice Alaboson, Lake Jackson, TX (US); Caroline Woelfle-Gupta, Midland, MI (US); Rashi Tiwari, Missouri City, TX (US); Jon W. Hobson, Lake Jackson, TX (US); Lawrence J. Effler, JR., Freeport, TX (US); Cristina Serrat, Freeport, TX (US); Alexander Williamson, Rosharon, TX (US); Viraj Shah, Freeport, TX (US)

(21) Appl. No.: 15/282,108

(22) Filed: Sep. 30, 2016

(51) Int. Cl. C08L 23/08; B29C 47/00; B29C 63/04

(52) U.S. Cl. CPC C08L 23/0815; B29C 47/0021; B29C 47/0057; B29C 47/0064; B29L 2009/00; C08L 2205/03; C08L 2205/18; B29K 2023/06; B29K 2995/0046; B29C 63/04

(57) ABSTRACT

The present disclosure relates to a method of promoting optimal stretching of stretch film during a wrapping operation, which method comprises at least the following steps. First a resin suitable for making stretch films is selected. Then a dispersed agent is selected, preferably one which has a refractive index similar to the selected resin such that when a film is made comprising the resin and the dispersed agent, the film will appear somewhat clear. The dispersed agent is then mixed with the resin and a film is formed from the resin containing the dispersed agent. Finally, a load is manually wrapped using such film, wherein during wrapping, the film is stretched to a level where the film becomes more opaque.

### FIELD OF THE INVENTION

The present invention relates to a method for providing a visual indication as to degree of elongation of a stretch film, particularly useful when using stretch film to manually unitize a load. The method involves providing a stretch film incorporating dispersed agents. The dispersed agents allow a visual change in the appearance of the film to be observed upon different levels of elongation of the film, thereby providing an indication to help ensure the optimum level of stretch is being used when using the stretch film for securing product. The specific level of elongation at visual change occurs can be adjusted by selection of the polymer matrix; the particular size, shape, amount and composition of the dispersed agents; and the amount and composition of any compatabilizing agent.

### BACKGROUND AND SUMMARY

Stretch films or stretch wrap, are highly stretchable plastic films that are wrapped around items in order to protect the item and/or in order to bundle smaller items into one larger unit. The stretch films provide a film around one or more products in order to stabilize, protect and help secure the cargo from tampering or theft. Typically stretch films are made of polyolefin materials such as linear low density polyethylene (“LLDPE”), low density polyethylene (“LDPE”), ethylene vinyl acetate copolymers (“EVA”) or polypropylene (“PP”), due to their balance of properties including elasticity.

These stretch films are frequently used to unitize pallet loads but also may be used for bundling smaller items. In practice, machine stretch films are elongated to 250-350% as they are wrapped around the goods and the elastic recovery of the stretch films keeps the items tightly bound. As such elongation levels are difficult to achieve by hand, most films intended for handwrapping are preoriented. Pre-oreintation involves using a machine to stretch the film to about 250% to 300% elongation, while creating another roll of film (the pre-oriented roll). This new pre-oriented roll has some level of stretchability left in it, typically on the order of 15 to 30% further elongation. A person using the pre-oriented roll for hand wrapping would only need to stretch the film by this additional amount in order to achieve a good holding force.

Whether machine wrapping or hand wrapping a load, the elongation should be optimized, as if the film is not elongated sufficiently, the film may slough off of the package or the goods may shift and break free during transportation, whereas if the elongation is too high, the goods may become damaged from the pressure imparted by the film and/or increased rates of film breakage will be observed. Unoptimized stretching is more common when handwrapping a load, due to the variability of human users.

However, automatic equipment is costly, requires more space, and is not well suited to non-uniform loads, and so is not universally used. Therefore, manually stretched films currently account for approximately 35% and 50% of the total stretch film market in North America and Europe, respectively.

Multilayer stretch films allow different functionality to be imparted to the films than would be obtainable using mono-layer films. For example, cling layers, barrier layers, and/or layers with specific physical properties such as puncture/tear/abuse resistance may be combined with layers formulated for their elastic properties to provide superior films. These multilayer films tend to be more expensive, however, heightening the importance of avoiding waste.

The present disclosure helps to addresses the lack of standardization (particularly in manual pallet wrapping) by providing a feature in the stretch film that actively interacts with the operator during the application process to provide a visual indication as to the level of elongation. This visual indication can be achieve through the use of dispersed agents. The film can be tailored to maximize the visual indication at the desired elongation.

Accordingly, in one aspect, the present disclosure relates to a method of promoting optimal stretching of stretch film during a wrapping operation, which method comprises at least the following steps. First a resin suitable for making stretch films is selected. Then a dispersed agent is selected, preferably one which has a refractive index similar to the selected resin such that when a film is made comprising the resin and the dispersed agent, the film will appear clear. The dispersed agent is then mixed with the resin and a film is formed from the resin containing the dispersed agent. Finally, a load is manually wrapped using such film, wherein during wrapping, the film is stretched to a level where the film becomes more opaque.

Benefits of this concept when applied to manual pallet wrapping include improving overall quality of wrapping and load security, quality control, and to investigate tampering.

### BRIEF DESCRIPTION OF THE DRAWINGS

FIG. 1 presents a photograph showing the change of opacity when stretch film containing a dispersed agent to an elongation of 300%

### DETAILED DESCRIPTION OF THE INVENTION

The term “polymer”, as used herein, refers to a polymeric compound prepared by polymerizing monomers, whether of the same or a different type. The generic term polymer thus embraces the term “homopolymer”, usually employed to refer to polymers prepared from only one type of monomer as well as “copolymer” which in the present disclosure refers to polymers prepared from two or more different monomers (i.e., for purposes of the present invention the term “copolymers” is used to generically mean polymers made from at least two different monomers and therefore includes what those skilled in the art might refer to as “terpolymers” as well as polymers made with more than three different monomers).

“Polyolefin” shall mean polymers comprising greater than 50% by weight of units which have been derived from alpha-olefins, and in particular alpha olefins having from 2-8 carbon atoms, including polyethylene and polypropylene.

“Polyethylene” shall mean polymers comprising greater than 50% by weight of units which have been derived from ethylene monomer. This includes polyethylene homopolymers or copolymers (meaning units derived from two or more comonomers).

Common forms of polyethylene known in the art include Low Density Polyethylene (LDPE); Linear Low Density Polyethylene (LLDPE); Ultra Low Density Polyethylene (ULDPE); Very Low Density Polyethylene (VLDPE); single site catalyzed Linear Low Density Polyethylene, including both linear and substantially linear low density resins (m-LLDPE); Medium Density Polyethylene (MDPE) and High Density Polyethylene (HDPE). Molecular weight of the polymer, which can be expressed as average values (Mn, Mw, Mz, where Mn is number average molecular weight, Mw is weight average molecular weight and Mz is Z average molecular weight), is correlated to the polymers melt index as determined according to ASTM D 1238 (2.16 kg, 190° C.).

These polyethylene materials are generally known in the art; however the following descriptions may be helpful in understanding the differences between some of these different polyethylene resins.

The term “LDPE” may also be referred to as “high pressure ethylene polymer” or “highly branched polyethylene” and is defined to mean that the polymer is partly or entirely homopolymerized or copolymerized in autoclave or tubular reactors at pressures above 14,500 psi (100 MPa) with the use of free-radical initiators, such as peroxides (see for example U.S. Pat. No. 4,599,392, herein incorporated by reference). LDPE resins typically have a density in the range of 0.916 to 0.940 g/cm³.

The term “LLDPE” or “Linear Low Density Polyethylene”, includes both resin made using the traditional Ziegler-Natta catalyst systems as well as single-site catalysts such as metallocenes (sometimes referred to as “m-LLDPE”). LLDPEs contain less long chain branching than LDPEs and includes the substantially linear ethylene polymers which are further defined in U.S. Pat. No. 5,272,236, U.S. Pat. No. 5,278,272, U.S. Pat. No. 5,582,923 and U.S. Pat. No. 5,733,155; the homogeneously branched linear ethylene polymer compositions such as those in U.S. Pat. No. 3,645,992; the heterogeneously branched ethylene polymers such as those prepared according to the process disclosed in U.S. Pat. No. 4,076,698; and/or blends thereof (such as those disclosed in U.S. Pat. No. 3,914,342 or U.S. Pat. No. 5,854,045). The Linear PE can be made via gas-phase, solution-phase or slurry polymerization or any combination thereof, using any type of reactor or reactor configuration known in the art, with gas and solution phase reactors being most preferred.

The term “HDPE” or High Density Polyethylene is sometimes used to refer to polyethylenes having densities greater than about 0.940 g/cm³, which are generally prepared with Ziegler-Natta catalysts, chrome catalysts or even metallocene catalysts. Similarly “MDPE” or Medium Density Polyethylene is sometimes used to refer to the subset of polyethylenes which have a density in the range of from about 0.926 to about 0.940 g/cm³).

The following analytical methods are used in the present invention:

Density is determined in accordance with ASTM D-792.

“Melt index” also referred to as “I₂” (or “MFR” for polypropylene resins) is determined according to ASTM D-1238 (for polyethylene resins 190° C., 2.16 kg; for polypropylene resins 230° C., 2.16 kg).

In one aspect of the present disclosure, a multilayer stretch film is provided. The multilayer stretch film comprises at least a first layer, wherein said first layer comprises a polyolefin resin. The film of this aspect of the disclosure further include at least a second layer, and a dispersed agent which may be in any or all layers of the film.

### First Layer

Any resin generally known in the art as being suitable for use in stretch film applications may be used in the first layer of the present disclosure. The resin preferably is a polyolefin resin comprised of greater than 70%, 80% or even 90% by weight of units which have been derived from alpha-olefins, and in particular alpha olefins having from 2-8 carbon atoms. Preferred polyolefins for use in the present disclosure include polyethylene, including LDPE, LLDPE, MDPE, and HDPE and polypropylene, including homopolymer polypropylene (h-PP), random copolymer polypropylene (RPP) and impact copolymer polypropylene.

In some embodiments the polyolefin comprises a linear low density polyethylene (LLDPE). The LLDPE suitable for stretch film application may advantageously have a density in the range of from 0.900 to 0.930 g/cm3. All individual values and subranges from 0.900 to 0.930 g/cm3 are included herein and disclosed herein; for example, the density can be from a lower limit of 0.900, 0.905, 0.908, 0.910, or 0.914 g/cm³ to an upper limit of 0.919, 0.920, 0.925, or 0.930 g/cm³.

The linear low density polyethylene compositions useful in the instant disclosure may advantageously have a melt index (I₂) in the range of from 0.3 to 10.0 g/10 minutes. All individual values and subranges from 0.3 to 10 g/10 minutes are included herein and disclosed herein; for example, the melt index (I₂) can be from a lower limit of 0.3, 0.6, 0.7, 1.0, 1.5, 2.0, 3.0 g/10 minutes to an upper limit of 4.0, 5.0, 8.0, 10.0 g/10 minutes.

The linear low density polyethylene compositions useful in the instant disclosure may comprise less than 35 percent by weight of units derived from one or more α-olefin comonomers other than ethylene. All individual values and subranges from less than 35 weight percent are included herein and disclosed herein; for example, the linear low density polyethylene composition may comprise less than 25 percent by weight of units derived from one or more α-olefin comonomers; or in the alternative, the linear low density polyethylene composition may comprise less than 15 percent by weight of units derived from one or more α-olefin comonomers; or in the alternative, the linear low density polyethylene composition may comprise less than 14 percent by weight of units derived from one or more α-olefin comonomers.

The α-olefin comonomers typically used in LLDPE's suitable for use in the present disclosure typically have no more than 20 carbon atoms. For example, the α-olefin comonomers may preferably have 3 to 10 carbon atoms, and more preferably 3 to 8 carbon atoms. Exemplary α-olefin comonomers include, but are not limited to, propylene, 1-butene, 1-pentene, 1-hexene, 1-heptene, 1-octene, 1-nonene, 1-decene, and 4-methyl-1-pentene. The one or more α-olefin comonomers may, for example, be selected from the group consisting of propylene, 1-butene, 1-hexene, and 1-octene; or in the alternative, from the group consisting of 1-hexene and 1-octene.

The linear low density polyethylene composition suitable for use in the present disclosure may comprise at least 65 percent by weight of units derived from ethylene. All individual values and subranges from at least 75 weight percent are included herein and disclosed herein; for example, the linear low density polyethylene composition may comprise at least 85 percent by weight of units derived from ethylene; or in the alternative, the linear low density polyethylene composition may comprise less than 100 percent by weight of units derived from ethylene.

Any conventional ethylene (co)polymerization reaction may be employed to produce such linear low density polyethylene compositions. Such conventional ethylene (co)polymerization reactions include, but are not limited to, gas phase polymerization process, slurry phase polymerization process, solution phase polymerization process, and combinations thereof using one or more conventional reactors, e.g. fluidized bed gas phase reactors, loop reactors, stirred tank reactors, batch reactors in parallel, series, and/or any combinations thereof. For example, the linear low density polyethylene composition may be produced via gas phase polymerization process in a single gas phase reactor; however, the production of such linear low density polyethylene compositions is not so limited to gas phase polymerization process, and any of the above polymerization processes may be employed. In one embodiment, the polymerization reactor may comprise of two or more reactors in series, parallel, or combinations thereof. Preferably, the polymerization reactor is one reactor, e.g. a fluidized bed gas phase reactor. In another embodiment, the gas phase polymerization reactor is a continuous polymerization reactor comprising one or more feed streams. In the polymerization reactor, the one or more feed streams are combined together, and the gas comprising ethylene and optionally one or more comonomers, e.g. one or more α-olefins, are flowed or cycled continuously through the polymerization reactor by any suitable means. The gas comprising ethylene and optionally one or more comonomers, e.g. one or more α-olefins, may be fed up through a distributor plate to fluidize the bed in a continuous fluidization process.

Suitable LLDPE polymers for use in the present disclosure include those commercially available from The Dow Chemical Company (for example, DOWLEX™, ELITE™, ELITE AT™, INNATE™ and AFFINITY™ resins).

In addition to LLDPE, other polyethylenes suitable for use in the present disclosure include low density polyethylene(s) (LDPE), particularly when blended with LLDPE. Such blends may comprise from less than 30 percent by weight of one or more low density polyethylene(s) (LDPE); for example, from 2 to 25 weight percent; or in the alternative, from 5 to 15 weight percent. The low density polyethylene preferably has a density in the range of from 0.915 to 0.930 g/cm³; for example, from 0.915 to 0.925 g/cm³; or in the alternative, from 0.918 to 0.922 g/cm³. The low density polyethylene preferably has a melt index (I2) in the range of from 0.1 to 5 g/10 minutes; for example, from 0.5 to 3 g/10 minutes; or in the alternative, from 1.5 to 2.5 g/10 minutes. The low density polyethylene preferably has a molecular weight distribution (Mw/Mn) in the range of from 6 to 10; for example, from 6 to 9.5; or in the alternative, from 6 to 9; or in the alternative, from 6 to 8.5; or in the alternative, from 7.5 to 9.

If LDPE is present as a blend with LLDPE, the blend composition may be prepared via any conventional melt blending process such as extrusion via an extruder, e.g. single or twin screw extruder. The LDPE, LLDPE, and optionally one or more additives may be melt blended in any order via one or more extruders to form a uniform blend composition. In the alternative, the LDPE, LLDPE, and optionally one or more additives may be dry blended in any order, and subsequently extruded to form a stretch film.

Polyolefin polymers other than polyethylenes can also be advantageously used in the present invention, and in particular polypropylene polymers and olefin block copolymers (OBCs) may be used. Propylene polymers include polypropylene homopolymer and copolymers, including random and impact copolymers, such as propylene/ethylene copolymers and are particularly well suited for use in the present invention. Propylene polymers having a 2 percent secant modulus, as measured by ASTM D 882, of about 150,000 psi and less are preferred. Propylene polymers also include the family of resins know as propylene based plastomers and elastomers which family includes those commercially available from ExxonMobil (VISTAMAXX™) and The Dow Chemical Company (for example, VERSIFY™).

Olefin block copolymers are a relatively new class of block copolymers. The term “block copolymer” or “segmented copolymer” refers to a polymer comprising two or more chemically distinct regions or segments (referred to as “blocks”) joined in a linear manner, that is, a polymer comprising chemically differentiated units which are joined (covalently bonded) end-to-end with respect to polymerized functionality, rather than in pendent or grafted fashion. Olefin block copolymers involve block copolymers made from olefins. The blocks differ in the amount or type of comonomer incorporated therein, the density, the amount of crystallinity, the type of crystallinity (e.g., polyethylene versus polypropylene), the crystallite size attributable to a polymer of such composition, the type or degree of tacticity (isotactic or syndiotactic), regio-regularity or regio-irregularity, the amount of branching, including long chain branching or hyper-branching, the homogeneity, and/or any other chemical or physical property. The block copolymers are characterized by unique distributions of both polymer polydispersity (PDI or Mw/Mn) and block length distribution, e.g., based on the effect of the use of a shuttling agent(s) in combination with catalysts. Olefin block polymers include those with ethylene as the dominant comonomer as well as those with propylene as the dominant monomer. Such materials are commercially available from The Dow Chemical Company under the INFUSE™ and INTUNE™ trade names.

Other resins known for use in stretch film applications may also be used in the present invention, including ethylene vinyl acetate copolymers (“EVA”), ethylene ethyl acrylate copolymers (“EEA”), ethylene acrylic acid copolymers (“EAA”) and Ethylene n-butyl acrylate copolymers (“EnBA”).

It is also contemplated that two or more of these base resins may be blended together to form the matrix of the first film layer. As explained below, it is believed that the cavitation caused by stretching which leads to a change in opacity of the film is partly a function of compatibility between the dispersed particles and the polymer matrix. Thus, depending on the nature of the dispersed particles, and the desired level of elongation, the polymer matrix may be designed to have more or less compatibility with the particles. For example, the more elastomeric LLDPEs will tend to be more compatible with dispersed acrylic beads. Accordingly, if an elastomeric LLDPE is blended with a less elastomeric LLDPE, the observed opacity change will occur at a higher elongation level than in a film comprising only the less elastomeric LLDPE.

Additional Layer(s)

In addition to the first layer comprising a polyolefin resin described above, the stretch films of the present disclosure also comprise one or more additional layers. The additional layers, if any, should be chosen so as not to unduly interfere with the stretchable nature of the stretch films.

These additional layers may advantageously be used to impart additional functionality to the film. For example, additional layers may be added to provide cling, barrier properties or additional physical properties such as puncture resistance, tear resistance or abuse resistance may be used in the present invention. These layers may comprise one or more different polymers as is generally known in the art. These include polyolefins which may be of the same types as described for the first layer so long as in any specific film it is a different composition than that which is used in the first layer (i.e., the layers must be distinguishable). Other materials for these additional layers can be, for example, polyamides (nylon), ethylene-vinyl alcohol copolymers, polyvinylidene chloride, polyester and their copolymers such as polyethylene terephthalate or PETG, ethylene-vinyl acetate copolymers, ethylene-acrylic acid copolymers, ethylene-methacrylic acid copolymers, graft modified polymers, styrenic block copolymers In some multilayer structures where a desired layer is not completely compatible with the first layer, an adhesion-promoting tie layer, such as PRIMACOR™ ethylene-acrylic acid copolymers available from The Dow Chemical Co., and/or ethylene-vinyl acetate copolymers may be desirable.

Preferably these additional layers are formed using coextrusion techniques, but other known methods of manufacture may also be suitable in some instances.

### Dispersed Agents

Stretch films of the present disclosure further include one or more dispersed agents. Dispersed agents for use in the present disclosure include any such agents known in the art. These materials are occasionally referred to as cavitating agents as they are often used to create voids in the film under typical processing conditions, thereby imparting breathability to films. The dispersed phase may comprise any material which will disperse in the continuous phase used to make the film and which will form voids when the corresponding film is stretched. Common materials for use as the dispersed agents include acrylic beads, inorganic fillers such as calcium carbonate particles or talc, glass beads, polystyrene (including GPPS, HIPS, ABS, SAN, styrene block copolymers, and mixtures thereof), polyethylene terephthalate (PET), polybutylene terephthalate, polycarbonate, and mixtures thereof. Thus, the polystyrene dispersed phase may comprise polystyrene, polyethylene terephthalate (PET), polybutylene terephthalate, and polycarbonate alone or in mixtures. The specific type of polystyrene is not particularly limited and includes, for example, GPPS, HIPS, ABS, SAN, styrene block copolymers, and mixtures thereof.

Ideally, the dispersed agents should be selected, and added in an amount, so as to have a similar refractive index as the polymer matrix of the film so that prior to elongation under use, the films appear clearer (that is, will have substantially lower haze values) than after desired elongation. The opacity can be quantified by haze measurements. Ideally, the dispersed agents will be selected so that the haze of the films prior to elongation will be less than 70%, preferably less than 50%, 35% or even 20%.

While clearer films (i.e. lower absolute haze values) may have aesthetic appeal in many applications, for purposes of the present invention, the important factor is that the film exhibits a noticeable difference in opacity upon elongation to the desired levels. Thus haze levels above these absolute amounts are possible so long as the increase in haze can still be readily observed by the user. It is preferred that the difference in haze between the pre-stretched state (whether such pre-stretched state is pre-oriented as typically used in handwrapping or non-preoriented as typically used in machine wrapping) and the desired elongation is at least 10%, more preferably 15% and most preferably at least 20%.

The dispersed agent should be added in an amount which will allow for a noticeable change in opacity during elongation but which will not cause failure or other detrimental effects during production or use. Typically, these materials may be added in an amount of from 1 to 10 percent by weight of the film layer to which it is added, preferably in an amount of from 2 to 8 percent.

The dispersed agents may be incorporated in any layer of the film. As each layers has a different crystalline structure, and each layer responds differently to elongation, the persons of ordinary skill in the art will understand that certain layers may be more desirable than others to allow for the dispersed agents to cause cavitation upon the desired level of elongation. In many applications, the dispersed agent will be incorporated into a layer comprising a polyolefin resin.

It will be appreciated by one skilled in the art that in general larger particles will produce large voids, resulting in a greater level of opacity at a given elongation, but also may affect the starting haze values (less clear films) and may cause issues with film integrity. It will readily be understood by those of ordinary skill in the art that the optimal particle size of the particles may vary depending on factors such as choice of materials, thickness of the overall film, and thickness of the film layer in which the particles are incorporated. In many applications, average particle sizes of from 1 to 10 microns may be desirable.

It has also been observed that dispersed agents having a generally spherical shape tend to produce a larger void than more elliptical particles under similar conditions. Thus, the shape and size of the particles can also be used to tailor the cavitation to provide the maximum visual indication at the desired elongation.

Compatabilizer

Cavitation around the dispersed agent is also believed to be a function of compatibility with the polymer matrix. The more compatible the dispersed agent is with the polymer matrix, the less voiding will be observed under similar conditions. Thus materials which operate to reduce the surface tension between the polymer matrix and the dispersed agents may optionally be used to further optimize the level at which cavitation (and hence the change in opacity) is observed. Depending on the resin used for the polymer matrix, and the choice of dispersed agents, many different materials may be used as compatabilizers. These include ethylene-acrylic copolymers, maleic anhydride grafted polyethylene, glycidial methacrylate grafted polyolefins and other materials known in the art. In general, the compatabilizers may comprise from one to about 25 percent by weight of the film layer(s) to which the dispersed agent is (are) added, with 5 to 20 percent being more typical.

Overall Film Structure

The film structures of the present disclosure may comprise any number of layers desired. Films having two, three, five, seven, nine layers or more are known in the art and can be used in the present disclosure. It is also contemplated that some of the layers may be microlayers.

The thickness of each layer of the film, and of the overall film, is not particularly limited, but is determined according to the desired properties of the film. Typical film layers (non-preoriented) have a thickness of from 1 to 200 μm, more typically from 5 to 100 μm. Typical films (again prior to any orientation) have an overall thickness of from 5 to 300 μm, more typically 10 to 100 μm.

The layers of the stretch films useful for the present invention may further comprise additional additives. Such additives include, but are not limited to, one or more hydrotalcite based neutralizing agents, antistatic agents, color enhancers, dyes, lubricants, fillers (in addition to the dispersed agent), pigments, primary antioxidants, secondary antioxidants, processing aids, UV stabilizers, nucleators, and combinations thereof. The film composition may contain any amounts of additives. In some applications, the polymer matrix composition may comprise from about 0 to about 10 percent by the combined weight of such additives, based on the weight of the polymer matrix composition including such additives. All individual values and subranges from about 0 to about 10 weight percent are included herein and disclosed herein; for example, the linear low density polyethylene composition may comprise from 0 to 7 percent by the combined weight of additives, based on the weight of the linear low density polyethylene composition including such additives; in the alternative, the linear low density polyethylene composition may comprise from 0 to 5 percent by the combined weight of additives, based on the weight of the linear low density polyethylene composition including such additives; or in the alternative, the linear low density polyethylene composition may comprise from 0 to 3 percent by the combined weight of additives, based on the weight of the linear low density polyethylene composition including such additives; or in the alternative, the linear low density polyethylene composition may comprise from 0 to 2 percent by the combined weight of additives, based on the weight of the linear low density polyethylene composition including such additives; or in the alternative, the linear low density polyethylene composition may comprise from 0 to 1 percent by the combined weight of additives, based on the weight of the linear low density polyethylene composition including such additives; or in the alternative, the linear low density polyethylene composition may comprise from 0 to 0.5 percent by the combined weight of additives, based on the weight of the linear low density polyethylene composition including such additives.

The film structures of the present disclosure may be made by conventional fabrication techniques, for example simple blown film (bubble) extrusion, biaxial orientation processes (such as tenter frames or double bubble processes), simple cast/sheet extrusion, coextrusion, lamination, etc. Conventional simple bubble extrusion processes (also known as hot blown film processes) are described, for example, in The Encyclopedia of Chemical Technology, Kirk-Othmer, Third Edition, John Wiley & Sons, New York, 1981, Vol. 16, pp. 416-417 and Vol. 18, pp. 191-192, the disclosures of which are incorporated herein by reference. Biaxial orientation film manufacturing processes such as described in the “double bubble” process of U.S. Pat. No. 3,456,044 (Pahlke), and the processes described in U.S. Pat. No. 4,352,849 (Mueller), U.S. Pat. Nos. 4,820,557 and 4,837,084 (both to Warren), U.S. Pat. No. 4,865,902 (Golike et al.), U.S. Pat. No. 4,927,708 (Herran et al.), U.S. Pat. No. 4,952,451 (Mueller), and U.S. Pat. Nos. 4,963,419 and 5,059,481 (both to Lustig et al.), the disclosures of which are incorporated herein by reference, can also be used to make the film structures of this invention.

The stretch films of the present invention should be suitable for use in stretch film applications. Thus the films of the present invention should have adequate physical properties such as Ultimate Tensile (ASTM D882), Elongation % (ASTM D882), Tear Resistance (ASTM D1922), Dart Drop (ASTMD1709), and pre-stretch elongation at break (Highlight method). While such values will vary depending on intended use and thickness of the films, for a film 20 micron film (0.8 mil), it is preferred that the stretch film have an Ultimate Tensile in the machine direction (“MD”) of at least 6000 psi, and in the cross direction (“CD”) of at least 4500 psi. Similarly, it is preferred that such film has an elongation in the MD of at least 300%, and in the CD of at least 400% (prior to any pre-orientation). Tear Resistance can be greater than about 75 grams in the MD and 250 grams in the CD. Such film also preferably has a dart drop pf greater than 50 grams, and a pre-stretch elongation at break of at least 250%.

In practice, the present disclosure relates to a method of promoting optimal stretching of stretch film during a wrapping operation, which method comprises at least the following steps. First a resin suitable for making stretch films is selected. Then a dispersed agent is selected, preferably one which has a refractive index similar to the selected resin such that when a film is made comprising the resin and the dispersed agent, the film will appear relatively clear. The dispersed agent is then mixed with the resin and a film is formed from the resin containing the dispersed agent. This film may optionally be pre-oriented as is typically done for films intended for hand-wrapping. Finally, a load is wrapped using such film, wherein during wrapping, the film is stretched to a level where the film becomes more opaque than observed prior to this final stretching (whether or not such film had been subjected to a pre-orientation step). Preferably the method is characterized by having a difference in haze value of at least 10% between the starting state (whether or not such starting state has been subjected to a pre-orientation step) and the desired elongation in use. More preferably this difference can be at least 15%, 20%, 30% or even 50%.

### Examples

In order to demonstrate the basic concept of the present disclosure a series of mono layer films are made using an ethylene-octene linear low density resin having a density of 0.920 g/cm3 and a melt index (190° C., 2.16 kg) of 1.0 g/10 min, except for Example 5, which was a 50/50 blend of an ethylene-octene linear low density resin having a density of 0.920 g/cm³ and a melt index (190° C., 2.16 kg) of 1.0 g/10 min and an ethylene-octene linear low density resin having a density of 0.87 g/cm³ and a melt index (190° C., 2.16 kg) of 5.0 g/10 min. The polymer resin is then optionally compounded with dispersed agent and compatabilizer as indicated in Table 1 using a Micro 18 Twin Screw Extruder. The compounded resin is then used to make film having a thickness of 1 mil using a Killion blown film line.

TABLE 1

| | | Amount of | | Compatabilizer |
|---|---|---|---|---|
| | Dispersed agent | Dispersed agent | Compatabilizer | amount |
| Example # | type | (wt %) | type | (wt %) |
| Ex1 | 5 um | 10 | none | none |
| | crosslinked | | | |
| | acrylic beads | | | |
| Ex2 | 5 um | 10 | ethylene- | 30 |
| | crosslinked | | acrylic | |
| | acrylic beads | | copolymer with | |
| | | | ~15 wt % ethyl | |
| | | | acrylate | |
| Ex3 | 5 um | 10 | ethylene- | 10 |
| | crosslinked | | acrylic | |
| | acrylic beads | | copolymer with | |
| | | | ~15 wt % ethyl | |
| | | | acrylate | |
| Ex4 | 0.5 um | 5 | none | none |
| | crosslinked | | | |
| | acrylic beads | | | |
| Ex5 (50/50 | 5 um | 10 | none | none |
| blended base | crosslinked | | | |
| resin) | acrylic beads | | | |
| Ex6 | 5 um | 10 | PE-maleic | 10 |
| | crosslinked | | anhydride | |
| | acrylic beads | | copolymer | |
| | | | (MAH content | |
| | | | ~7 wt %) | |
| Ex7 | 5 um | 5 | ethylene- | 10 |
| | crosslinked | | acrylic | |
| | acrylic beads | | copolymer with | |
| | | | ~15 wt % ethyl | |
| | | | acrylate | |
| Ex8 | 5 um | 2 | none | none |
| | crosslinked | | | |
| | acrylic beads | | | |
| Ex9 | 5 um | 9 | none | none |
| | crosslinked | | | |
| | acrylic beads | | | |
| CEx10 | none | none | none | none |

These films can then be stretched to different degrees of elongation, and haze at each level can be measure according to ASTM D-1003. Absolute Haze is presented in Table 2 (values are %) whereas Table 3 shows differences between the unstretched film and the film elongated to the indicated elongation (i.e. haze at indicated elongation−haze at 0% elongation).

TABLE 2

| | Examples | | | | | | | | | |
|---|---|---|---|---|---|---|---|---|---|---|
| Elongation | Ex 1 | Ex 2 | Ex 3 | Ex 4 | Ex 5 | Ex 6 | Ex 7 | Ex 8 | Ex 9 | CE 10 |
| 0% | 61.9 | 63.4 | 65.2 | 28.1 | 68.5 | 83.3 | 33.8 | 16.8 | 43.4 | 15.8 |
| 10% | 65.7 | 65.8 | 64.4 | 29.8 | 68.4 | 87.3 | 33.5 | 16.4 | 38.3 | 17.7 |
| 20% | 64.2 | 65.6 | 63.8 | 27.9 | 66.2 | 86.8 | 31.6 | 15.2 | 38.4 | 17.0 |
| 50% | 66.9 | 69.9 | 66.8 | 28.0 | 68.0 | 87.1 | 37.4 | 19.2 | 47.6 | 18.8 |
| 75% | 73.6 | 72.3 | 72.2 | 25.8 | 71.3 | | | | | |
| 100% | 76.9 | 76.4 | 76.4 | 32.9 | 77.4 | 87.2 | 44.8 | 22.0 | 61.6 | 17.9 |
| 120% | | | | | | 92.2 | | | | |
| 150% | | | | | | 88.7 | | | | |

TABLE 3

| | Examples | | | | | | | | | |
|---|---|---|---|---|---|---|---|---|---|---|
| Elongation | Ex 1 | Ex 2 | Ex 3 | Ex 4 | Ex 5 | CE 6 | Ex 7 | Ex 8 | Ex 9 | CE 10 |
| 0% | 0 | 0 | 0 | 0 | 0 | 0 | 0 | 0 | 0 | 0 |
| 10% | 3.8 | 2.4 | −0.8 | 1.7 | −0.1 | 4 | −0.3 | −0.4 | −5.1 | 1.9 |
| 20% | 2.3 | 2.2 | −1.4 | −0.2 | −2.3 | 3.5 | −2.2 | −1.6 | −5 | 1.2 |
| 50% | 5 | 6.5 | 1.5 | −0.1 | −0.5 | 3.8 | 3.6 | 2.4 | 4.2 | 0 |
| 75% | 11.7 | 8.9 | 7 | −2.3 | 2.8 | | | | | |
| 100% | 15 | 13 | 10.7 | 4.8 | 8.9 | 3.9 | 11 | 5.2 | 18.2 | 2.1 |
| 120% | | | | | | 8.9 | | | | |
| 150% | | | | | | 5.4 | | | | |

Examples 4, 6, and 8 all exhibited less than 10% difference in haze at 100% elongation, and it was observed that the change in opacity of these examples were not as striking. Example 10 is comparative as no dispersed agents were present, and therefore no significant change in opacity was observed. It is hypothesized that the compatabilizing agent used in Example 6 was too effective so that cavitation was not observed at up to 150% elongation. It is hypothesized that the dispersed agent used in Example 4 had too small a particle size (Ex4) or was added in too small an amount (Ex8) to have optimal cavitation. It was observed that at this film thickness, at lower absolute haze values, it was harder to observe a change in opacity, even when the difference in haze was significant. In particular the change in opacity of Examples 7 and 9 did not appear visually as striking as the other examples. Thus at least for films of this thickness it may be preferred that the difference in haze between the unstretched film and the desired elongation be at least 10% and that the resulting haze at the desired elongation be at least 50%.

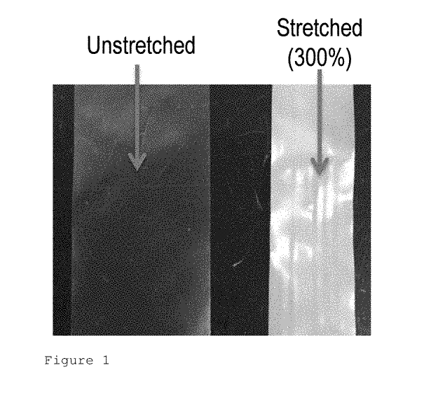

FIG. 1 presents a photograph showing the change of opacity when stretch film containing a dispersed agent to an elongation of 300%.

It is specifically intended that the present disclosure not be limited to the embodiments and illustrations contained herein, but include modified forms of those embodiments including portions of the embodiments and combinations of elements of different embodiments as come within the scope of the following claims. It is further contemplated that the limitations set forth in the following dependent claims may be combined with limitations in any other dependent claim, mutatis mutandis.

What is claimed is:

1. A method of promoting optimal stretching of stretch film during a wrapping operation comprising the steps of:
a. selecting a polyolefin resin;
b. selecting a dispersed agent having a refractive index similar to the selected polyolefin resin such that when a film is made comprising the polyolefin resin and the dispersed agent, the film will have a certain level of clarity;
c. admixing the dispersed agent into a melt of the polyolefin resin;
d. forming a film from the admixture of step c; and
e. wrapping an object using the film of step d, while stretching the film to a level where the film becomes more opaque.

2. The method of claim 1 further comprising the step of pre-orienting the film formed in step d prior to wrapping the object, and wherein the level of clarity after the pre-orientation is still less than when stretching to the final desired elongation.

3. The method of claim 1 wherein the film becomes more opaque upon elongation in the range of from 200 to 300 percent.

4. The method of claim 1 wherein the dispersed agent is added in an amount of from 1 to 15 percent by weight of the film.

5. The method of claim 1 where the dispersed agent is an organic or inorganic filler.

6. The method of claim 1 where the dispersed agent is selected from the group consisting of acrylic beads, calcium carbonate particles, glass beads or combinations thereof.

7. The method of claim 1 wherein the film exhibits an increase in haze value of at least 10% during step e and where the final stretched film has a haze of at least 50%.

8. The method of claim 1 wherein the film exhibits an increase in haze value of at least 20% during step e.

9. The method of claim 1 further comprising the step of adding a compatabilizer to the film.

10. The method of claim 9 wherein the compatabilizer is selected and added in an amount to tune the change from transparent to opaque to occur when the desired range of elongation of the film has been achieved.

11. The method of claim 9 wherein the compatabilizers is added in an amount of from 1 to 50 percent by weight of the film.

12. The method of claim 9 wherein the compatabilizer is selected from the group consisting of low density polyethylene, ethylene-acrylic copolymer, maleic anhydride grafted polyethylene or combinations thereof.

13. The method of claim 1 where the film is a multilayer film.

14. The method of claim 1 wherein the polyolefin resin is selected from the group consisting of LLDPE (including mLLDPE, znLLDPE), LDPE, HDPE, MDPE, PP (including RCP, hPP and ICP) and combinations thereof.

15. The method of claim 12 where the polyolefin resin comprises a linear low density polyethylene.

16. The method of claim 1 wherein the dispersed agent has an average size (T50) of from 1 to 10 microns.
